(19) United States
(12) Patent Application Publication
(10) Pub. No.: US 2026/0162418 A1
(43) Pub. Date: Jun. 11, 2026

(54) FIXATION TOLERANT OBJECT RECOGNITION WITH A LOGARITHMICALLY-COMPRESSED VISUAL FILED

(71) Applicant: Cognitive Scientific Al, Inc., Northborough, MA (US)

(72) Inventors: Marc W. Howard, Northborough, MA (US); Ami Falk, Northborough, MA (US); Wei Zhong Goh, Northborough, MA (US); Per B. Sederberg, Northborough, MA (US)

(21) Appl. No.: 19/410,924

(22) Filed: Dec. 5, 2025

Related U.S. Application Data
(60) Provisional application No. 63/729,152, filed on Dec. 6, 2024.

(51) Int. Cl. G06V 10/82; G06N 3/0464; G06T 5/20

(52) U.S. Cl. CPC G06V 10/82; G06N 3/0464; G06T 5/20

(57) ABSTRACT

Systems and methods are described herein that utilize neural networks to learn and implement convolutional filters that can be used over a logarithmically-compressed image. These filters are tolerant to changes in the relative visual fixation of an image, that is, a change of origin in log-polar coordinates. Deep networks, such as those that use multilayered neural networks, may be configured to implement the proposed method for filter learning and to take advantage of the exponential savings associated with a logarithmically-compressed image space with minimal sacrifice of fixation invariance.

### CROSS-REFERENCE TO RELATED APPLICATION

The present application claims priority to and the benefit of U.S. Provisional Patent Application No. 63/729,152, entitled “Fixation Tolerant Object Recognition with a Logarithmically-Compressed Visual Field,” and filed on Dec. 6, 2024, the contents of which are incorporated herein by reference in their entirety.

### BACKGROUND

Convolutional neural networks (CNNs) have been extremely influential in the development of computer vision systems. Standard CNNs take images in a Cartesian system as input and exploit the translation equivariance of conventional convolution to learn filters that are invariant to the location of a pattern in an image (Cohen and Welling, 2016). Translation equivariance is a property where a function remains unchanged when the input is translated, that is, applying a translation to an input results in the output being translated by the same amount. However, it has been known for several decades that the mammalian visual system does not take a Cartesian mapping of the visual world (Daniel and Whitteridge, 1961; Hubel and Wiesel, 1974; Schwartz, 1977; Van Essen, Newsome, and Maunsell, 1984). The mammalian visual system, at least outside the fovea, appears to use a log-polar coordinate system instead of a Cartesian system.

Regular convolution, or Cartesian-based convolution, can be understood as a function over translations, as described below:

$$\begin{matrix}\{ f * g \} ( x ) = \int f ( {x}^{′} ) g ( {x}^{′} - x ) {dx}^{′} & ( 1 ) \\ = \int f ( {x}^{′} ) [ {τ}_{x} g ( {x}^{′} ) ] {dx}^{′} , & ( 2 )\end{matrix}$$

where [symbol] denotes the translation operator and the data f is compared to a filter g at each possible translation. Thus, f*g can be understood as a function over the group of translations. Regular convolution is equivariant with translation, that is, translating f (or g) prior to the convolution yields the same result as translating the result of the convolution of f and g.

However, convolution over logarithmic coordinate systems is no longer translation equivariant and therefore different from regular convolution over Cartesian systems. However, human perception, which is based on a logarithmic coordinate system, is known to be robust to image translations, showing zero-shot generalization to non-verbalizable displaced images (Han, Roig, Geiger, and Poggio, 2020). Zero-shot generalization refers to the ability to make predictions on unseen tasks without any prior training on those specific instances.

### BRIEF SUMMARY

In an aspect of this disclosure, a method for processing images within a deep neural network is described. The method includes defining a filter in Cartesian coordinates. The method further includes constructing log-polar filters from projections of the filter in log-polar coordinates for multiple relative locations, wherein both the Cartesian coordinates and the log-polar coordinates are two-dimensional coordinates. Additionally, the method includes comparing the log-polar filters to information of an image mapped into the log-polar coordinates for determining a position of the image in three dimensions. For instance, the comparing can be based on a convolution operation, however, other techniques can also be used. Moreover, the method includes performing additional processing of the image in the deep neural network based on the position of the image in three dimensions.

In another aspect of this disclosure, a system to process images within a deep neural network is described. The system includes a processor configured to define a filter in Cartesian coordinates. The processor is further configured to construct log-polar filters from projections of the filter in log-polar coordinates for multiple relative locations, wherein both the Cartesian coordinates and the log-polar coordinates are two-dimensional coordinates. The processor is additionally configured to compare the log-polar filters to information of an image mapped into the log-polar coordinates to determine a position of the image in three dimensions. For instance, the comparison can be based on a convolution operation, however, other techniques can also be used. Moreover, the processor is further configured to perform additional processing of the image in the deep neural network based on the position of the image in three dimensions. The system also includes a memory configured to store, at least temporarily, one or more of the filter in Cartesian coordinates, the projections of the filter in log-polar coordinates for multiple relative locations, the information of an image mapped into the log-polar coordinates, and the position of the image in three-dimensions.

In yet another aspect of this disclosure, a computer readable medium is described that includes program instructions to process images within a deep neural network, and where the execution of the program instructions by one or more processors of a hardware system causes the one or more processors to define a filter in Cartesian coordinates. The execution of the program instructions by one or more processors of the hardware system further causes the one or more processors to construct log-polar filters from projections of the filter in log-polar coordinates for multiple relative locations, wherein both the Cartesian coordinates and the log-polar coordinates are two-dimensional coordinates. The execution of the program instructions by one or more processors of the hardware system additionally causes the one or more processors to compare the log-polar filters to information of an image mapped into the log-polar coordinates for determining a position of the image in three dimensions. For instance, the comparison can be based on a convolution operation, however, other techniques can also be used. Moreover, the execution of the program instructions by one or more processors of the hardware system further causes the one or more processors to perform additional processing of the image in the deep neural network based on the position of the image in three dimensions.

### BRIEF DESCRIPTION OF THE DRAWINGS

FIG. 1A illustrates an example of a world coordinate system, in accordance with aspects of this disclosure.

FIG. 1B illustrates an example of a projection onto a Cartesian coordinate system, in accordance with aspects of this disclosure.

FIG. 1C illustrates an example of a projection of an object in the world onto the Cartesian and cortical coordinate systems, in accordance with aspects of this disclosure.

FIG. 1D illustrates an example of the different properties of an image projected onto the log-polar part of cortical coordinates, in accordance with aspects of this disclosure.

FIG. 2 illustrates an example of coordinate-independent filters in different coordinate systems, in accordance with aspects of this disclosure.

FIGS. 3A and 3B illustrate examples of the properties of translation and scaling in cortical coordinates, in accordance with aspects of this disclosure.

FIGS. 4A and 4B illustrate examples of the dependence of the resolution of filters in cortical coordinates on the ratio of filter size to extent of the fovea, in accordance with aspects of this disclosure.

FIGS. 5A-5D illustrate examples of how object decoding in log-polar space generalizes across scaling, in accordance with aspects of this disclosure.

FIGS. 6A-6E illustrate examples of how object decoding in log-polar space generalizes across translation in the XY plane, in accordance with aspects of this disclosure.

FIGS. 7A and 7B illustrate an example of the one-to-one mapping between three-dimensional (3-D) coordinates via two-dimensional (2-D) inputs, in accordance with aspects of this disclosure

FIG. 8 illustrates an example of a flowchart of a dynamic computer vision (DCV) model, in accordance with aspects of this disclosure.

FIG. 9 an example of a method for processing images within a deep neural network, in accordance with aspects of this disclosure.

FIG. 10 illustrates an example of a hardware system for processing images within a deep neural network, in accordance with aspects of this disclosure.

### DETAILED DESCRIPTION

As described in further detail herein, neurally-inspired receptive fields that have equivalent resolution over log polar coordinates enable translation-invariant object identification from log-polar coordinates. That is, it is possible to use the concept of neurally-inspired receptive fields to implement convolution over logarithmic coordinate systems that supports translation equivariance. Standard convolution over a logarithmically-compressed axis is similar to a group equivariant convolutional neural network (G-CNN) over the scaling semigroup. G-CNNs are a type of neural network that leverages the symmetries present in data (e.g., images, video) to improve learning performance. First, y is defined as y=log x and the f(x) and g(x) over y are referred as f^{LOG}(y)=f(x) and g^{LOG}(y)=g(x). Now, translating in y is equivalent to rescaling in x, so that the standard convolution between f^{LOG} and g^{LOG} can be written as a function over scalings of x:

$$\begin{matrix}\{ {f}^{LOG} * {g}^{LOG} \} ( y ) = \int {f}^{LOG} ( {y}^{′} ) {g}^{LOG} ( {y}^{′} - y ) {dy}^{′} & ( 3 ) \\ = \int {f}^{LOG} ( {y}^{′} ) [ {τ}_{y} {g}^{LOG} ( {y}^{′} ) ] {dy}^{′} & ( 4 ) \\ = \int f ( {x}^{′} ) [ {𝒮}_{{e}^{y}} g ( {x}^{′} ) ] \frac{{dx}^{′}}{{x}^{′}} , & ( 5 )\end{matrix}$$

where the scaling operator [symbol] _{q} horizontally stretches the graph of a function by a factor of q, [symbol] _{q}f(x)=f(x/q). This is closely related to the Mellin convolution. This mathematical property of log scales has been exploited to build convolutional neural networks (CNNs) that are invariant to rescaling of their inputs in time series problems (Jacques, Tiganj, Sarkar, Howard, and Sederberg, 2022). One of the benefits of logarithmic compression is that the data structure is extremely efficient, since it involves sampling log N points rather than N points. In the context of vision, scaling an image about the origin appears as a translation in log-polar coordinates, enabling standard CNNs over log-polar coordinates to generalize to rescaled images (Jansson & Lindeberg, 2022).

Although log-polar coordinates are scale-covariant, taking scaling about the origin to translation along a radial coordinate (e.g., log r), they are no longer translation-equivariant. That is, log-polar coordinates do not allow for a translation to an input to result in the output being translated by the same amount. Translating an image in 2-D Euclidean space (e.g., Cartesian coordinate system) results in dramatic changes when projected into log-polar coordinates. However, as mentioned above, human object recognition or human perception is translation-invariant. Humans are able to show zero-shot generalization from a novel pattern that is presented at the periphery of their field of view to translated versions of the pattern near the fovea (Han et al., 2020). As such, the present systems and methods leverage this finding to implement a way to construct translation-invariant, or at least translation-tolerant filters, over log-polar space. In the context of this disclosure, the terms log-polar space, log-polar coordinates, log-polar plane, log-polar system, and log-polar coordinate system are used interchangeably. Similarly, the terms Cartesian space, Cartesian coordinates, Cartesian plane, Cartesian system, and Cartesian coordinates system are also used interchangeably.

An algorithm or method is described in more detail below to implement translation-invariant, or at least translation-tolerant filters, over log-polar space. Starting from a given filter describing an object in the three-dimensional (3-D) world, it is possible to accommodate translation by constructing the appearance that filter would take over a log-polar cortical coordinate system when translated to different locations. Additional details regarding the log-polar cortical coordinate system are provided below. At each possible two-dimensional (2-D) translation, the translated filter is compared to observed data. One way to implement this comparison is by performing a convolution over log-polar cortical coordinates. The scale-covariance of standard convolution over the logarithmic radial axis (see e.g., Eq. 5 described in more detail below) provides information about the object's apparent size. Given a filter describing an object of fixed size in the 3-D world, the 2-D translation, and a one-dimensional (1-D) convolution provide the match to the filter over 3-D coordinate system that maps onto position in the 3-D world.

### Algorithm

The pattern of light that is created over a log-polar coordinate system depends in a non-trivial way on its position relative to fixation (e.g., visual aim or gaze). If the choice of the object's position is independent of the choice of fixation, it could have appeared at any displacement to the viewer. The strategy for constructing or implementing fixation-tolerant filters that still exploit the significant efficiencies provided by the compression of log-polar coordinates is to: (1) define the filter outside of log-polar coordinates and then (2) construct the appearance that the filter would have had in log-polar coordinates for many choices of relative location. A comparison of these log polar filters to the data is carried out, and this can be done in various ways. For instance, one method is standard convolution, which exploits the scale-covariance of a logarithmic scale (see e.g., Eq. 5) to provide information about the apparent size of the image. This approach provides three coordinates to describe the match of the filter to the data: two dimensions for the displacement of the filter plus the output of the convolution conveying information about the scale of the match. These three coordinates, two for translation of the filter and one from the scale parameter that results from comparing the appearance to the filter, can be mapped onto 3-D position in the world up to constant that describes the actual size of the physical object in the world. In place of convolution to compare the translated filter in log-polar coordinates, one could use other techniques.

### Coordinate Systems in the World and the Visual System

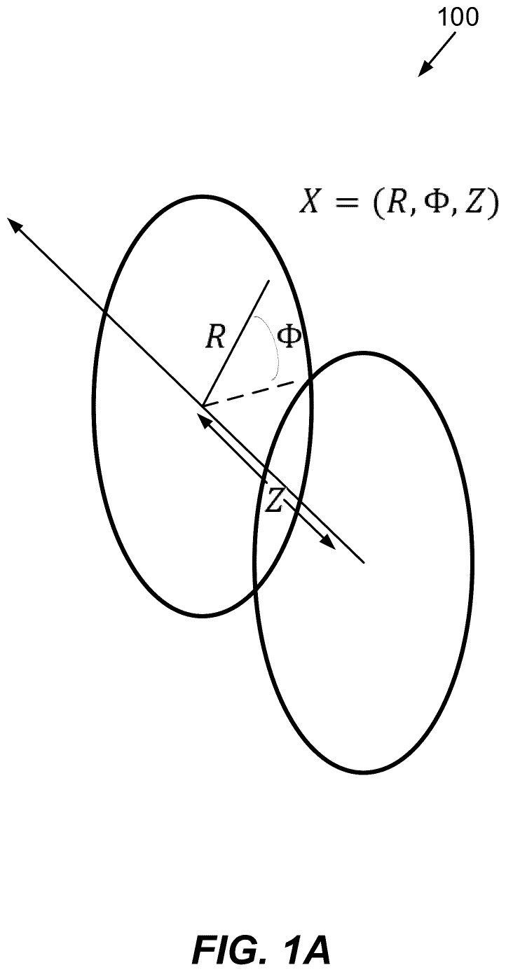

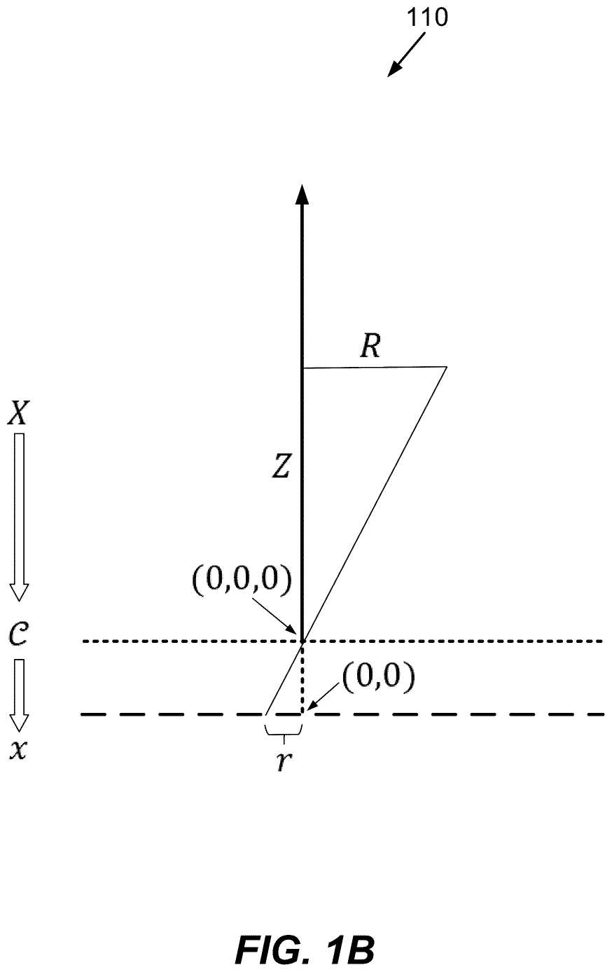

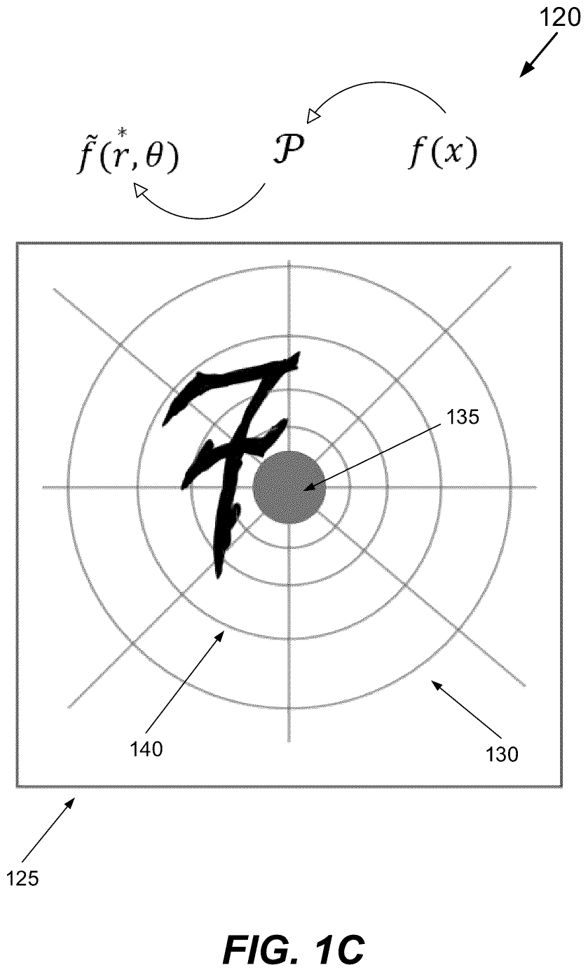

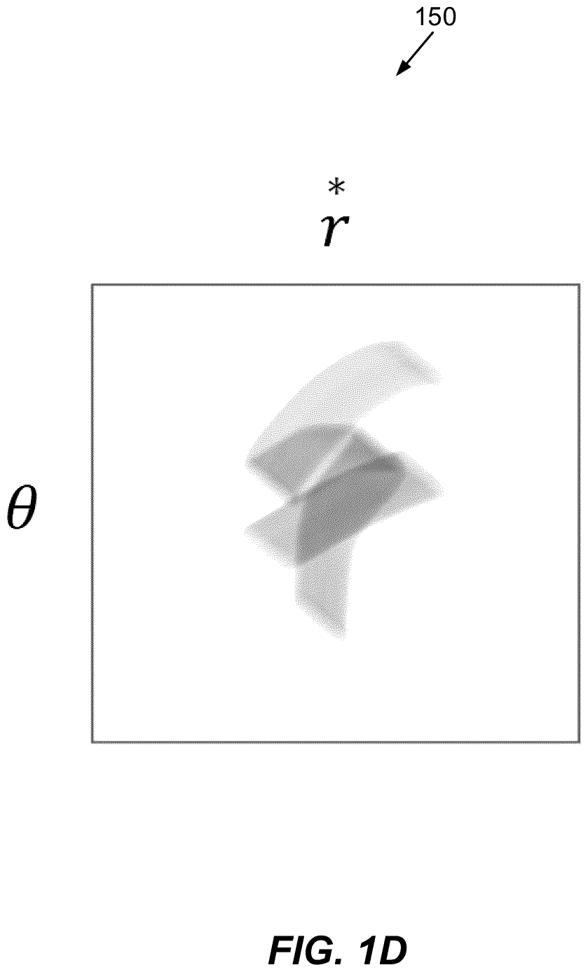

As part of the overall analysis needed to learn, construct, or implement fixation-tolerant filters for log-polar coordinates it is important to understand how to map the different types of coordinate systems. FIGS. 1A-1D provide a description of the mapping of three different coordinate systems: (1) the Euclidean external world X=(R, Φ, Z), (2) the Cartesian coordinate system x, and (3) the log-polar coordinate system

$$( {r}^{*} , θ ) .$$

FIG. 1A illustrates diagram 100 that shows an example of the Euclidean external world, X, where the origin of the world coordinate system is located at the aperture of the viewer and where the three coordinates in this system (R, Φ, Z) are identified.

FIG. 1B illustrates diagram 110 that shows an example of a view from above of a point in the world coordinate system, X, projecting onto the Cartesian coordinate system, x. In this view, points in the world coordinate system project rays through the pinhole aperture at the origin (mapping [symbol] ) onto a 2-D “screen” lying unit distance behind the aperture. The origin of the 2-D screen is the nearest point on the screen from the origin of the 3-D world system.

FIG. 1C illustrates diagram 120 that shows an example of the projection of an object in the world, here a stylized MNIST seven can be expressed in two coordinate systems on the plane. MNIST refers to the Modified National Institute of Standards and Technology database of handwritten digits that is commonly used for training image processing systems. In this case, f(x) is a standard Cartesian coordinate system 125. Sometimes it is possible to express x in polar coordinates. Additionally,

$$\tilde{f} ( {r}^{*} , θ )$$

describes the projection (operator [symbol] ) of the image onto a cortical coordinate system 130. The cortical coordinate system 130 combines fovea 135 (solid red circle at the center) with log-polar region 140 (as shown by a set of concentric circles and radial lines passing through the fovea).

FIG. 1D illustrates diagram 150 of an example of the projection of an image (the MNIST seven) in the log-polar region of the cortical coordinate system having very different properties than standard Cartesian coordinates. In this example, the image of the MNIST seven is significantly distorted.

Referring back to FIG. 1A, it is possible to map coordinates of point sources of light in the external world (e.g., the 3-D world) onto cylindrical coordinates X=(R, Φ, Z). The external world provides a 2-D image to the viewer via a pinhole aperture at the origin of this 3-D coordinate system (0,0,0) (see e.g., FIG. 1B). For a lens camera, it would be the lens that lies at the origin of the 3-D coordinate system.

Thus, FIG. 1B shows the mapping between a point source of light in 3-D and the 2-D location of its image on the plane as [symbol] : [symbol] ³→ [symbol] ². In this case, the 3-D world can therefore project to any or both of two coordinate systems, a Cartesian grid (represented by the square in FIG. 1C) and a log-polar cortical coordinate system (represented by the concentric circles and radial lines in FIG. 1C). Each of these systems can be chosen such that a point source of light at R=0 projects to the origin for all values of Z.

It is possible to assume that the locations of the Cartesian grid samples are on a discrete square lattice, but it need not be so limited and other sampling approaches may also be used. As such, f[x] may refer to the pattern of light falling at each position x on the Cartesian grid.

The 2-D input f[x] is projected onto a set of receptors \tilde{f} over two disjoint regions, the fovea and the log-polar region, as shown in FIG. 1C. Within a fovea of radius

$$‖ x ‖ < {{r}^{*}}_{0} ,$$

\tilde{f} is simply equal to f[x]. Outside the fovea, the spatial coordinates of each “pixel” are aligned to a cortical coordinate system in which the neurons sample f[x] over a region in the neighborhood of their spatial coordinate. The spatial coordinates of different neurons are evenly spaced over log polar coordinates.

Fovea: In the human retina, the fovea covers a region of a few degrees of visual angle (roughly the width of a person's thumb at arm's length). The fovea serves as a small region with high visual acuity. It also avoids numerical issues associated with a log polar coordinate system as r→0, If

$${{r}^{*}}_{0}$$

is in units of spacing between the points in the Cartesian grid, then modulo effects due to the discreteness of the grid, there are

$$π {{r}^{*}}_{0}^{2}$$

pixels in the fovea. Convolution in the fovea is translation equivariant as in standard CNNs. For this reason, this disclosure focuses much more attention on the cortical coordinate system than on the area covered by the fovea.

Cortical coordinate system: Outside the fovea, each neuron in this discrete population has a receptive field over x that is concisely described using polar coordinates over x. The neurons in the log-polar region have receptive fields with the same relative shape controlled by two parameters,

$${r}^{*}$$

and θ, as illustrated in FIG. 1C and FIG. 1D. In the log-polar region, the ith value of

$${r}^{*}$$

is chosen so that

$${{r}^{*}}_{i + 1} - {{r}^{*}}_{i} = c {{r}^{*}}_{i}$$

$$so that$$

$${{r}^{*}}_{i} = {( 1 + c )}^{i} {{r}^{*}}_{0}$$

$$and$$

$$i = {log}_{1 + c} {{r}^{*}}_{i} - {log}_{1 + c} {{r}^{*}}_{0} .$$

The angular coordinate of the jth value of θ is 2πj/n_{θ}. Each pair of

$${{r}^{*}}_{n}$$

and θⱼ has a corresponding neuron with receptive field centered on that location. It is possible to envision the set of neurons over the log-polar region as a rectangular grid, as illustrated in FIG. 1D. The notation

$${r}^{*}$$

is used to refer to the set of all

$${{r}^{*}}_{i} , {r}^{*} = \{ {{r}^{*}}_{0} , {{r}^{*}}_{1} , … \} .$$

### When

$${r}^{*}$$

appears as the axis of a figure, it is meant to convey position along this ordered set.

Moving along the θ=0 axis starting from

$${{r}^{*}}_{0}$$

at the beginning of the log-polar region, if N discrete samples of x are covered or passed, then log_{1+c}N discrete samples or are covered

$${r}^{*}$$

are covered or passed. Notably, the number of values of θ for each

$${r}^{*}$$

is constant, so that the number of pixels in the log-polar region of the cortical coordinate system goes up like n_{θ} log_{1+c}N rather than ζN² for the Cartesian grid.

Each neuron in \tilde{f}

$$[ {r}^{*} , θ ]$$

has a “receptive field” over f[x]. The characteristic scale in the

$${r}^{*}$$

direction associated with

$${{r}^{*}}_{i}$$

is chosen such that

$${σ}_{i} = {e}^{{{r}^{*}}_{i}} .$$

Coupled with the logarithmic scale for

$${r}^{*} ,$$

this ensures that adjacent receptive fields have the same overlap in

$$x / {r}^{*} .$$

These choices correspond to a population of neurons that implements a Fechner law scale of radial distance. Additionally, it may be needed that the receptive fields are the product of unimodal functions over

$$x / {r}^{*}$$

and θ. That is, θ receptive fields are chosen to be von Mises, with scale parameter κ and mean θⱼ and

$${r}^{*}$$

receptive fields are chosen to be gamma functions that implement the analytic solution to the Post Inversion formula (Shankar & Howard, 2012).

It is desirable to choose the parameters κ and k, which correspond to concentration parameters of the von Mises and the degree of approximation of the post approximation of the inverse Laplace respectively, and the number of cells in each dimension such that the relative overlap between adjacent receptive fields is the same in each direction.

An operator [symbol] is written that takes f to \tilde{f} (see e.g., FIG. 1C). Outside the fovea, [symbol] can be implemented as a matrix

$$P = {P}_{j}^{i}$$

that takes the vector over neurons at each particular location in the plane f[xᵢ] and writes it to the jth cell in

$$\tilde{f} [ {{r}^{*}}_{j} , {θ}_{j} ] .$$

For a neuron centered on a particular point in log-polar coordinates, the values Pₒ over x are understandable as the receptive field of that neuron over Cartesian space. The shape of receptive fields in the cortical coordinate system up have already been described to a constant.
Mapping Position in the World onto Log-Polar Coordinates

For the choice of cylindrical coordinates each point in the 3-D world X=(R, Φ, Z) maps onto x=(r, θ) as a right triangle such that θ=Φ and r∝R/Z. The expression θ=Φ is the definition of θ. The physical situation shown in FIG. 1B would suggest a reflection such that θ=Φ+π, however, this is difficult to keep track of so θ is defined to be reflected for simplicity.

Consider two points describing a rigid body in the world (e.g., the 3-D world in FIG. 1A). Let's describe the difference between those points as V=X₂−X₁. It is important to know how the difference between them appears in log polar coordinates,

$$( {r}^{*} , θ ) .$$

The patterns evoked by the two points can be measured, in one example, via ordinary convolution over r* so the difference between the two points is defined as

$$Δ {r}^{*} = {{r}^{*}}_{2} - {{r}^{*}}_{1} .$$

Next is to consider how changing Z only (e.g., the distance to the viewer) between the two points affects the image in

$$( {r}^{*} , θ ) .$$

First, note that Φ is unaffected, so one can ignore θ and just ask about the effect on

$${r}^{*} .$$

### Because

$$r = R / Z , {{r}^{*}}_{1 ( 2 )} = log {R}_{1 ( 2 )} - log Z and Δ {r}^{*} = log \frac{{R}_{2}}{{R}_{1}} for all Z .$$

Thus, translating an object in the world by changing its value of Z (e.g., moving the object away from or closer to the viewer) scales its image in f[x] about the origin. Referring to a particular point in the 3-D world as X,

$${Δ}_{Z}^{} X = {q}_{} X , \qquad ( 6 )$$

where the scale factor is

$$q = \frac{1}{1 + Δ / Z} .$$

From this, it is seen that [symbol] , the mapping from world coordinates to the Cartesian plane (see e.g., FIG. 1B), is covariant to translations in the Z direction,

$${Δ}_{Z}^{} = {q}_{} . \qquad ( 7 )$$

Translations in the R direction yield translations in the r direction that depend on the Z coordinate

$${Δ}_{R}^{} = {Δ / Z}_{r}^{} , \qquad ( 8 )$$

recalling that the screen lies unit distance behind the origin of the 3-D coordinate system. For completeness, it is noted that translation in the Φ direction is simply equivariant:

$${Δ}_{Φ}^{} = {Δ}_{θ}^{} . \qquad ( 9 )$$

Going from Cartesian coordinates to log-polar cortical coordinates results in the following expression:

$${log α}_{} \{ f \} ( {r}^{*} , θ ) = \{ f ( {α}_{} x ) \} ( {r}^{*} , θ ) . \qquad ( 10 )$$

Comparing the right-hand side (rhs) of this expression to Eq. 7, it is noted that translating a point source of light in the 3-D world in the Z direction translates its image in \tilde{f} along the

$${r}^{*}$$

direction.

Building position-tolerant filters in log polar: First consider both data f[x] and filters g[x] in the Cartesian plane. Ignoring the fovea, the projection of the image from the Cartesian coordinates can be written as

$$\tilde{f} [ {r}^{*} , θ ] = f ( x )$$

for the log-polar region of the cortical coordinates.

The origin of the Cartesian coordinates and cortical coordinates depend on the current line of gaze, a ray extending from the image plane through the aperture into the real world. Moving the aperture, which corresponds to a movement of the eye, would result in a different ray. Such movement would change the coordinates in the world of a point source and so too would the coordinates in the Cartesian and cortical coordinate systems. Given a filter g[x], it is important to know how an image corresponding to g would have appeared if it were translated by (ρ, φ) in 2-D polar coordinates along the plane.

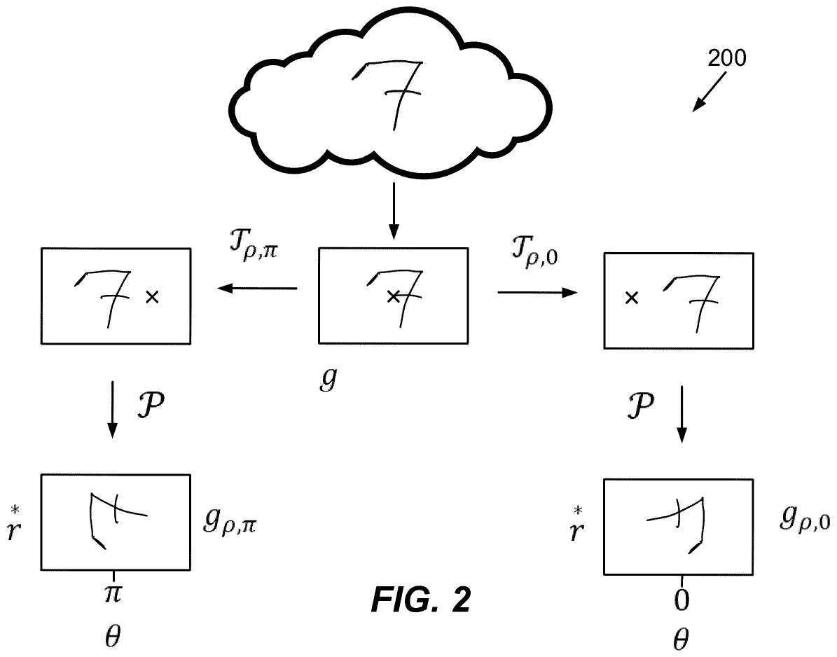

FIG. 2 shows diagram 200 that illustrates coordinate-independent filters in different coordinate systems. In this example, a stylized MNIST seven is an image to which a filter is to be applied. A “true filter” g can be understood as a filter that is independent of coordinate system. The filter g[x] can be learned and refers to a pattern describing activation as a function of position along a Cartesian grid. The filter is translated within the Cartesian coordinate system and then projected into the cortical coordinate system in accordance with Eq. 11 below. For example, a translation of the filter by (ρ, π) in the Cartesian grid is shown to the left, which is then followed by a projection ( [symbol] ) into the cortical coordinate system. Similarly, a translation of the filter by (ρ, 0) in the Cartesian grid is shown to the right, which is then followed by a projection ( [symbol] ) into the cortical coordinate system. It is thus possible to write

$${\tilde{g}}_{ρ , ϕ} [ {r}^{*} , θ ] = h ( ρ ) \{ {ρ , ϕ}_{} g \} [ {r}^{*} , θ ] \qquad ( 11 )$$

for the projection of the Cartesian filter after translating g[x] by a displacement (ρ, φ) described in polar coordinates. The scalar function h(ρ) is a normalization function. Details on how to choose this normalization function are provided below.

Because it is a function over log-polar coordinates, \tilde{g}_{ρ,φ} inherits the properties of log polar space described above. For example, translation of a fixed source of light along Z rescales the f caused by that object and thus translates \tilde{f} over

$${r}^{*} .$$

This means that performing convolutions over

$${r}^{*}$$

between \tilde{f} and \tilde{g}_{ρ,φ} can identity relative movement in the Z direction.

The match of a filter can be evaluated against the available data using the following “convolution”:

$$\{ \tilde{f} , {\tilde{g}}_{ρ , ϕ} \} [ {a}^{⋆} ] = {\sum }_{{r}^{*} , θ} \tilde{f} [ {{r}^{*}}_{i} , {θ}_{j} ] {\tilde{g}}_{ρ , ϕ} [ {{r}^{*}}_{i} - {a}^{*} , {θ}_{j} ] .$$

The sum on the right-hand side (rhs) is over each discrete value

$${{r}^{*}}_{i}$$

and θⱼ. Rather than convolving over θ, the choice is to sum over θ. This means that Eq. 12 is not rotation equivariant. This is not an essential property of the method. Rotation invariance may be useful in some environments. The variable

$${a}^{*}$$

is understood as a lag along the ordered set

$${r}^{*}$$

and inherits the same conventions.

Each filter is thus associated with three coordinates, (ρ, φ,

$${a}^{*} )$$

corresponding to the arguments of the maxima (argmax) of Eq. 12. These coordinates can be mapped onto positions X in the 3-D world up to a constant that corresponds to the size of the object generating the image \tilde{f}. Other methods or techniques of comparison can be used in place of Eq. 12 that yield parameters analogous to

$${a}^{*} .$$

Range of Resolution: Consider a filter g[x] with radius m. In the fovea, each of the pixels within x can be distinguished in \tilde{g}. Outside the fovea, individual pixels in g average over progressively larger regions in x as

$${r}^{*}$$

increases. This means that the resolution \tilde{g}_{ρ,φ} can provide in distinguishing different parts of the image depends on φ. For instance, if an image, say the stylized MNIST seven in FIG. 2, is to the left of fixation, the right side of the image falls into a higher resolution area of \tilde{g}. An alternative approach defines the filter g in a space assembled by combining the highest resolution area at each angle of relative placement. This mitigates changes in resolution as a consequence of angular translation at the cost of complexity in the definition and construction of \tilde{g}_{ρ,φ}. If filters are defined in Cartesian space, there is no difficulty aligning within the fovea.

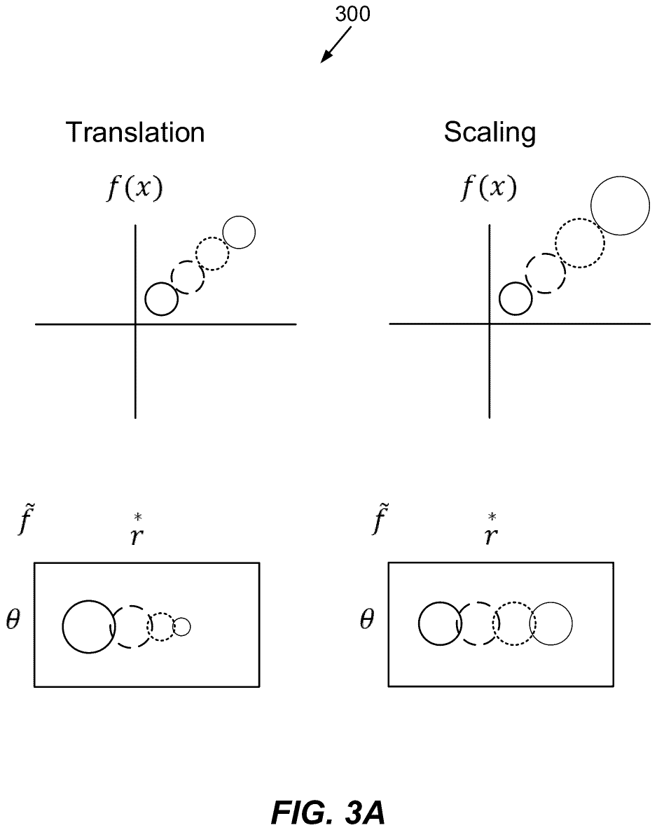

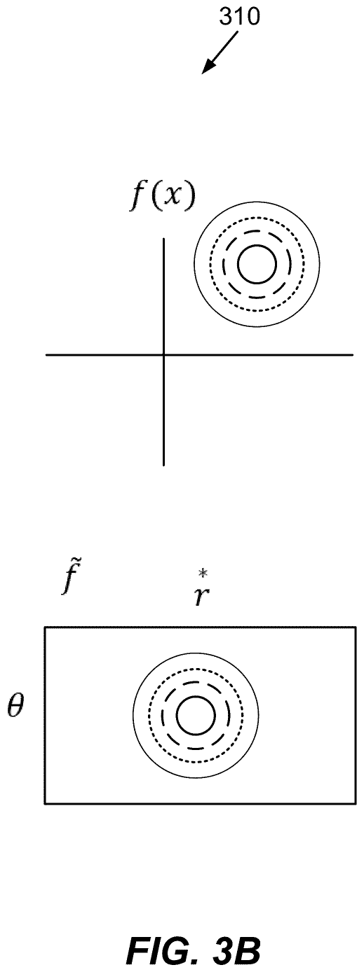

In addition to changes in resolution that result from angular translation, there are also consequences for resolution that result from radial translation. For example, FIGS. 3A and 3B illustrate diagrams 300 and 310 respectively, that show properties of scaling and translation in cortical coordinates. The left side of FIG. 3A illustrates how translating a pattern in f(x), here a circle, as shown at the top, reduces its angular extent in \tilde{f}, as shown at the bottom. For filters, this places a finite amount of spatial resolution from g[x] into a smaller region in \tilde{g}_{ρ}. The right side of FIG. 3A illustrates how scaling a pattern in f(x), as shown at the top, does not affect the spatial resolution in \tilde{f} as rescaling is simply translation, as shown at the bottom. In the example in FIG. 3B, a pattern f[x] can appear at any size and eccentricity. Here a circle is first scaled by different amounts, then translated by the same amount (relative to the center of the pattern), as shown at the top. If a filter can match the angular extent of the pattern in \tilde{f} at any displacement

$${r}^{*} ,$$

it can utilize all the resolution in g[x], modulo effects across the extent of the image due to angular translation φ.

In view of the examples in FIGS. 3A and 3B, as a pattern in the Cartesian grid is translated by progressively larger values of ρ, the area covered over

$$( {r}^{*} , θ )$$

space changes. The area of

$${\tilde{g}}_{ρ} ( {r}^{*} , θ )$$

in cortical coordinates thus provides a useful proxy for how well the individual pixels in g[x] can be utilized to distinguish objects in the visual field.

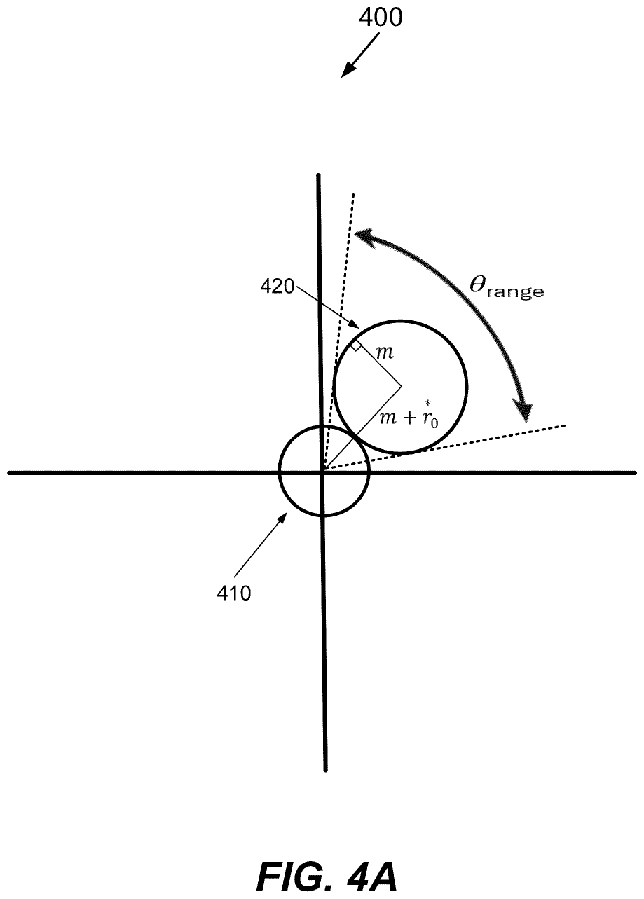

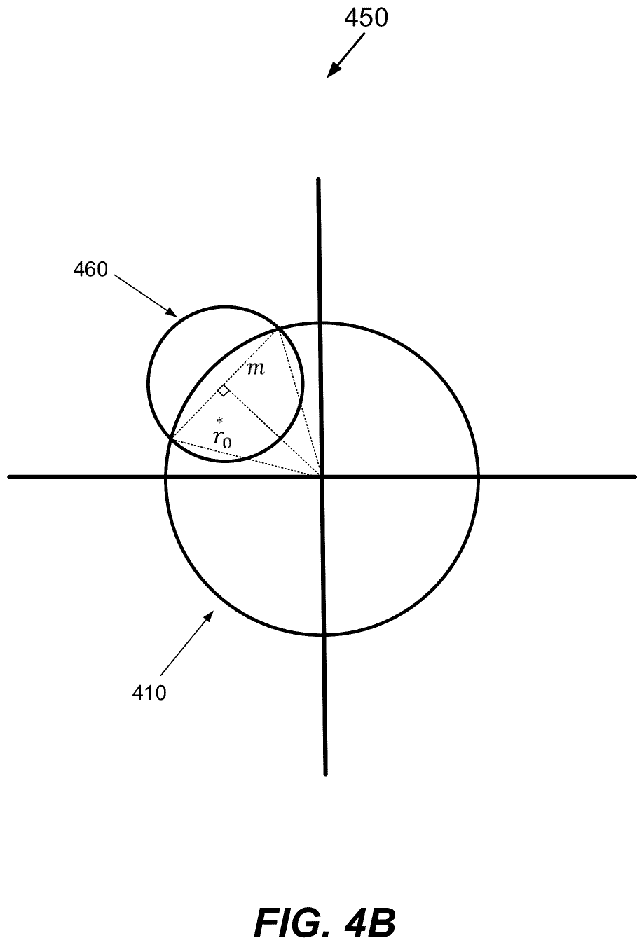

FIGS. 4A and 4B illustrate diagrams 400 and 450 respectively, that show how the resolution of filters in cortical coordinates depends on the ratio of filter size to extent of the fovea. The choice of m, the radial extent of g[x], and

$${{r}^{*}}_{0} ,$$

the radial extent of the fovea, affects the angular extent that go can cover. In FIG. 4A, an assumption is made that filter 420 has been translated such that is entirely out of fovea 410. Because scaling corresponds to transition in

$${r}^{*} ,$$

this means that filter 420 is able to precisely identify patterns with that angular extent for the remainder of the visual field. As

$$m / {{r}^{*}}_{0} ,$$

gets big, this angle increases to an upper limit of π. In FIG. 4B, the maximum angle covered by filter 460 as it is translated through fovea 410 sets the maximum angular extent it can cover. For

$$m < {{r}^{⋆}}_{0} ,$$

the extent is

$$2 {sin}^{- 1} \frac{m}{{{r}^{⋆}}_{0}} . For m \geq {{r}^{⋆}}_{0} ,$$

the angular extent is 2π. This means it can cover. For the extent is that a filter g[x] can cover a region with any angular extent using nearly all the resolution in the set of Cartesian weights.

Referring back to FIG. 4A, scale-covariance implies that once a filter (e.g., filter 420) is barely outside fovea 410 it maintains the same resolution throughout the visual field. The angular extent a filter can cover is determined by the choices of m and

$${{r}^{⋆}}_{0} .$$

As the filter leaves the fovea entirely, the filter covers a region

$${θ}_{r ang} = 2 {sin}^{- 1} \frac{1}{1 + \frac{{{r}^{⋆}}_{0}}{m}}$$

As mentioned above, when

$$m / {{r}^{⋆}}_{0}$$

grows without bound, this asymptotes at π.

Referring back to FIG. 4B, if perfect translation is not required, the angle that a filter can cover at all, perhaps involving distortions due to the foveal region, is determined by the maximum angle covered as the filter (e.g., filter 460) emerges from fovea 410. For

$$m < {{r}^{⋆}}_{0} ,$$

the extent is

$$2 {sin}^{- 1} \frac{m}{{{r}^{⋆}}_{0}} . For m \geq {{r}^{⋆}}_{0} ,$$

the angular extent is 2π.

Choosing normalization h(ρ): As Cartesian filters translate away from the origin, they cover less area when projected into log-polar space. The function of the factor h(ρ) is to control for this change in area when comparing \tilde{g}_{ρ} to the data. The details of how to choose h(ρ) depend on the details of how the weights of the filters are chosen.

In \tilde{g}_{ρ,φ}, to compensate for the diminishing activation due to logarithmic compression at large amounts of translation by ρ, normalization is carried out by a factor of h(ρ) (Eq. 11). In the following examples, h(ρ) is computed as the inverse of the sum of the projection of a disk translated by p with radius equal to the maximum edge length of g:

$${[ h ( ρ ) ]}^{- 1} = {\sum }_{{r}^{⋆} , θ} \{ {ρ}_{} g ° \} [ {r}^{⋆} , θ ] ,$$

where g° denotes a disk of radius equal to m centered at the origin on the Cartesian plane. In the continuum limit h(ρ)∝ρ⁻². To eliminate possible numerical issues associated with discretization and choices of parameters, h(ρ) was computed empirically.

### EXAMPLES

The following examples are used to show the effect of the various techniques described herein. All such examples are merely illustrative and non-limiting. In some aspects, the process starts with a filter g[x] that matches some data f[x] on the Cartesian plane. The question is then whether the filter \tilde{g} matches \tilde{f} after various transformations corresponding to movement of an object in the world. In Example 1, f[x] is scaled around the origin, as if an object centered at R=0, Φ=0 was translated in the Z direction closer or further from the viewer. In Example 2, f[x] is translated by some amount in the Cartesian plane and report the translation in polar coordinates (ρ, θ). In 3-D this corresponds to moving an object in the X, Y plane without changing Z. In Example 3, f[x] is translated in the Cartesian plane and then scaled around the origin, as if the object were moving in three dimensions.

### Methods

For each of the examples below each \tilde{g}_{ρ,φ} is compared to \tilde{f} according to Eq. 12. Accuracy is defined as the probability that the filter corresponds to f[x] by providing the highest match among a set of other filters. For the matching filter, the values of (ρ, φ, a*) that provide the best match are taken and these are compared to (R, Φ, Z).

Log-polar space: The log-polar space is defined based on the following parameters:

$$\vert {r}^{⋆} \vert = 70 , \vert θ \vert = 70 , {{r}^{*}}_{0} = 3 , {{r}^{*}}_{max} = 150 , c = \text{.06} , κ = 241.2 , and k = 331.14 .$$

concentration parameters κ and k are chosen respectively in [symbol] f(x) such that each

$$( {r}^{*} , θ )$$

center is approximately two standard deviations away from adjacent receptive fields along the radial and angular axes. This guarantees overlap of the log-polar receptive fields without over-sampling.

Properties of filters: The filters g[x] are square sets of pixels in 2-D Cartesian space, masked to a discrete approximation of a circle. Each filter's side length (diameter) preferably has an odd number of pixels so there exists a central pixel. To create the circle mask, pixels at locations greater than or equal to a radius m relative to this central pixel are set to zero. The actual size of the filter is example-dependent but is set to fully contain the object of interest.

### Example 1: Generalization from Central Fixation to Rescaling

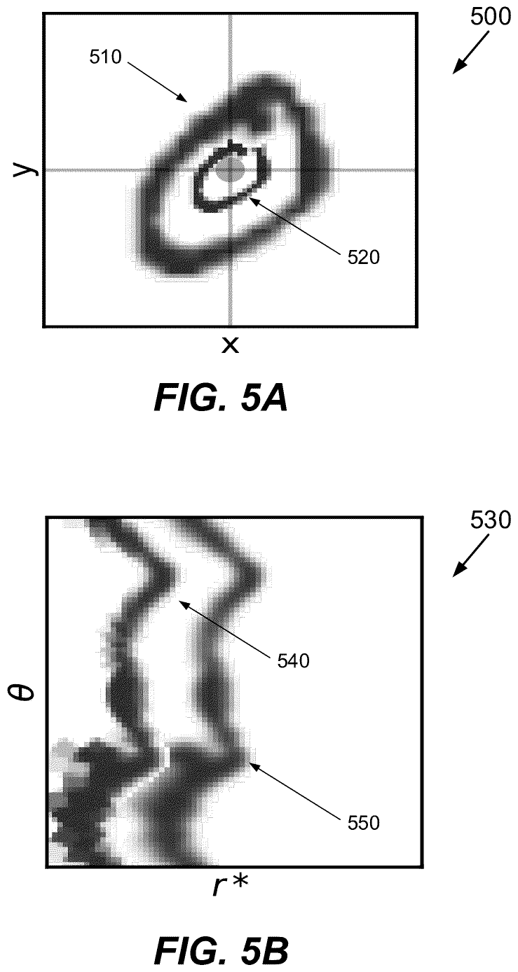

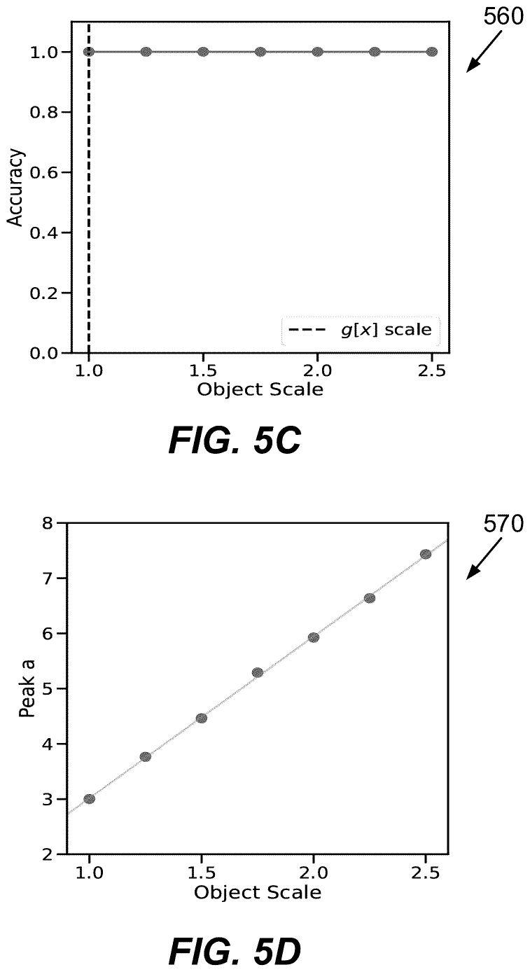

The first example tests the ability to decode objects that are scaled relative to a central fixation. Note that scaling an image in 2-D is analogous to translation of an object along the Z axis (i.e., moving an object closer or farther away from the observer). In this example ten samples of MNIST handwritten digits, one for each digit, and the samples are scaled in 2-D space about a central fixation (see e.g., FIG. 5A), which manifests as a translation in log-polar space (see e.g., FIG. 5B). To avoid the singularity at the log-polar origin, the fixation center is masked out with a circle of radius

$${{r}^{*}}_{0} = 3$$

before scaling each image.

Thus, FIGS. 5A and 5B illustrate diagrams 500 and 530 respectively, that show how object decoding in log-polar space generalizes across scaling. Translation in the Z direction scales objects in Cartesian space, as shown by plots 510 and 520 in diagram 500 of FIG. 5A, which maps to translation in log-polar space, as shown by plots 540 and 550 in diagram 530 of FIG. 5B. Consequently, there is no loss of model performance when decoding scaled objects, as shown by chart 560 of FIG. 5C. The object scale in Cartesian space has a direct relationship to the apparent size of objects as represented in the model with peak match in a, as shown by chart 570 of FIG. 5D. The line in chart 570 is a regression line (Slope=2.928, Intercept=0.089, R²=0.999).

To test generalization across scales, the convolution from Eq. 12 is applied with 10 filters (one for each digit) to the 10 input images at each scale. Image identity is extracted by taking the max over

$${a}^{*}$$

and then argmax over the 10 filters to determine whether the highest activation matches the true identity of the input image. As illustrated in FIG. 5C, the decoding accuracy based on the convolution remains perfect across a range of scales of the input image despite the original filters \tilde{g} remaining unchanged. Further, as shown in FIG. 5D, the object scale maps onto the a where the match is greatest from the convolution. Given that scaling an object on the 2-D Cartesian plane is the same as translating it along the Z axis, this suggests an ability to reconstruct an object's relative depth if its size is known.

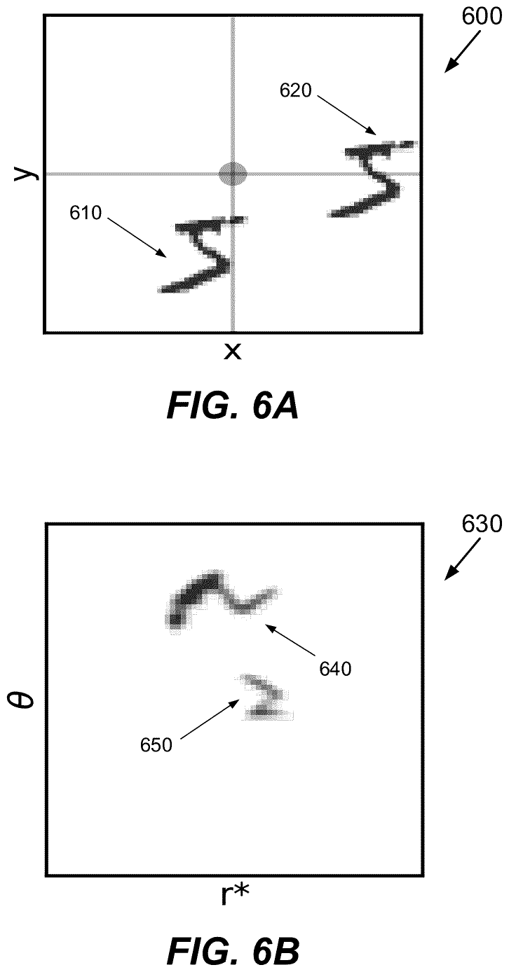

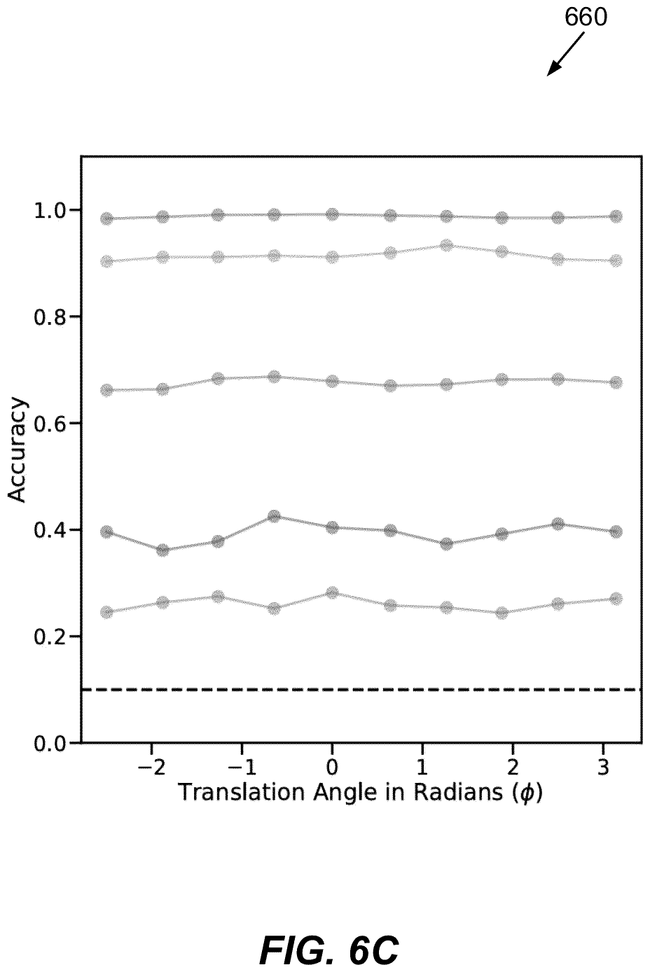

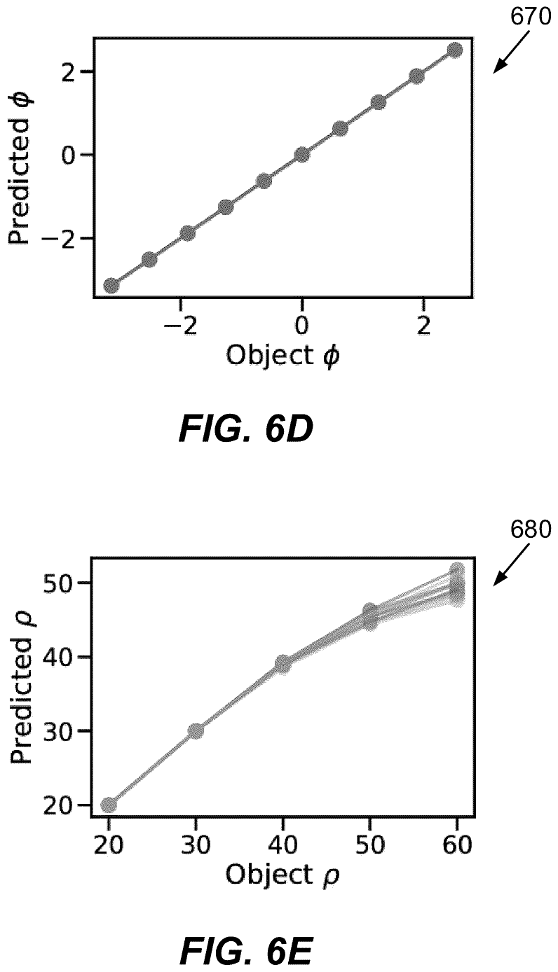

### Example 2: Generalization from Peripheral Fixation to Translation

Whereas scaling in Cartesian space is translation in log-polar, translation in Cartesian space (see e.g., diagram 600 in FIG. 6A) warps objects in log-polar space (see e.g., diagram 630 in FIG. 6B). That is, translation in the XY plane in the world, as shown by objects 610 and 620 in FIG. 6A, gives rise to translation in Cartesian space, but such translation tends to warp objects in log-polar space, as shown by objects 640 and 650 in FIG. 6B. Moreover, \tilde{g}_{ρ,φ} mirrors the warping as a function of the translation radius ρ and angle φ. As such, it is possible to apply the known transformation of filters stored in Cartesian space translated to new locations \tilde{g}_{ρ,φ}. These translated filters will then match translated objects, modulo resolution loss as objects move farther into the periphery (i.e., as ρ increases).

To demonstrate identification of translated objects via the semi-group convolution of translated filters described above, decoding accuracy is averaged over 1000 samples of sets of 10 MNIST digits, each translated to a range of locations specified by radius ρ and angle φ. Accuracy is determined for each digit presentation by identifying which digit filter has the maximum activation in the convolution output over ρ, φ, and

$${a}^{*} .$$

As illustrated in chart 660 or FIG. 6C, translations to different angles at a particular radius retains largely constant performance, whereas performance drops off as a function of radius, due to the loss of resolution away from the origin in cortical coordinates (ρ, indicated by the lines in chart 660 going from 60 to 20 in steps of 10). Chance performance is indicated by the dashed line at the bottom of the chart.

While the maximum activations from the convolution allow for object identification, one question is whether the peak activations on the convolution dimensions correspond to the actual location of the translated object. Turns out that the object translations in Cartesian space have a direct relationship to the position of objects as represented in the model with peak match in angle φ and radius ρ. For example, chart 670 of FIG. 6D demonstrates that the peak activations of the convolution align precisely with the objects' angle φ. Chart 680 of FIG. 6E shows that as the radius of translation ρ increases so too does the reconstructed value of ρ. At large translations, as accuracy decreases due to loss of spatial resolution in cortical coordinates, the reconstructed ρ underestimates the actual ρ.

### Example 3: 3-D Coordinates Reconstruction from 2-D Inputs

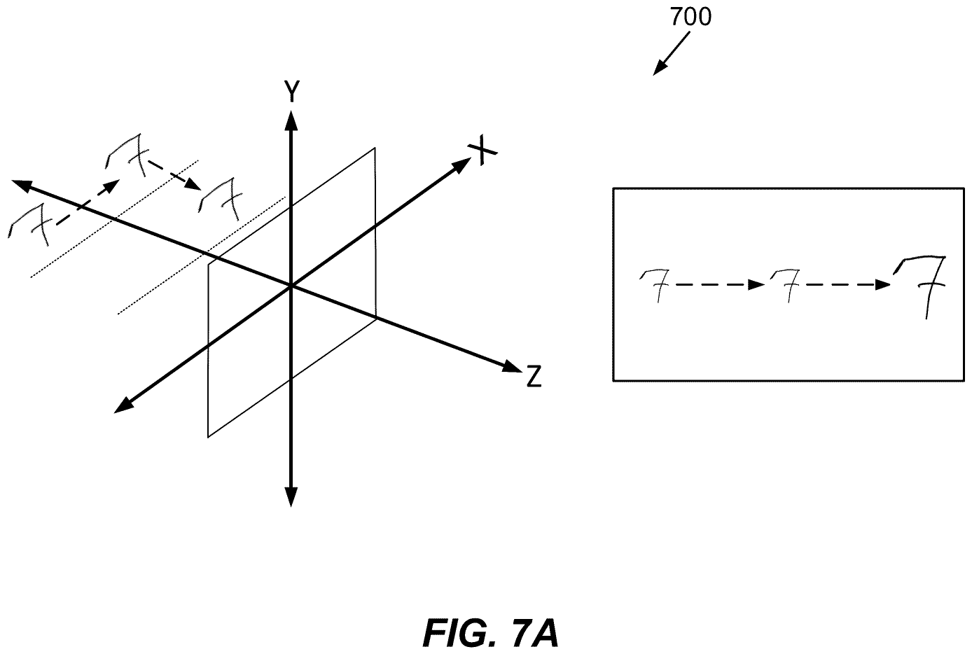

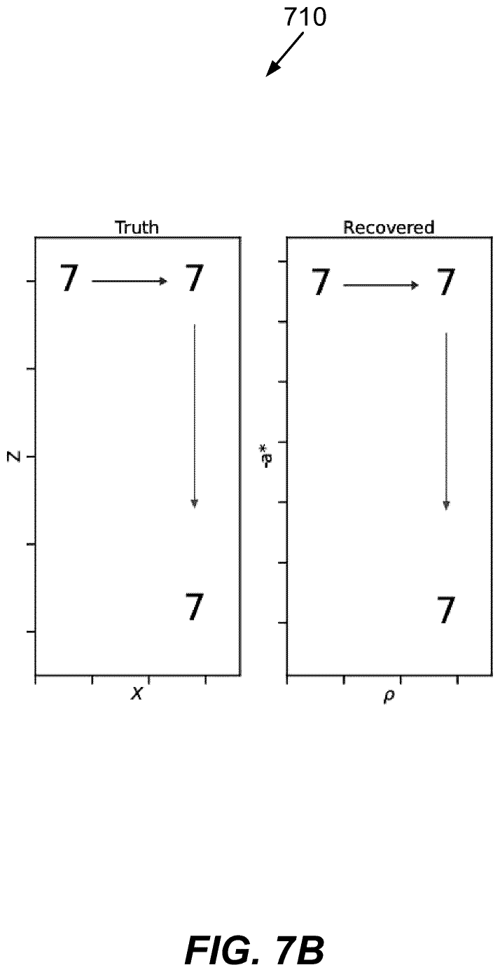

In this example, Euclidean X and Z translations are combined to illustrate the ability to reconstruct the 3-D coordinates of objects from their 2-D projection onto the image plane. The 3-D coordinate recovery is tested for three still images of constant size, as illustrated in diagram 700 of FIG. 7A (left panel). Specifically, a scenario is created where an object first moves to the right and then towards the observer. These movements manifest as translations and scaling of the object onto the 2-D input to the convolution (see FIG. 7A, right panel).

This example illustrates that there is a one-to-one mapping between 3-D coordinates via 2-D inputs. Here, an object (a stylized number seven) moves to the right and then towards an observer (left panel). The convolution receives the projection of the object onto the 2-D Cartesian plane at the three locations (right panel). The object's coordinates in 3-D space (X, Y, Z) map onto to the cortical coordinates (ρ, φ, and

$${a}^{*} )$$

based on peak activations or the convolution described in Eq. 12. Although they are not on the same scale, there is a direct correspondence between cortical coordinates and the location of the object as it moves through 3-D space. Note, the Y and φ dimensions are omitted from this illustration for simplicity.

This example is intended to reconstruct position, not decode what object is there, thus a single matching filter is tested at the range of ρ values that cover the possible movements in X, while scaling due to movement in the Z plane is handled by the

$${a}^{*}$$

dimension in the convolution. As mentioned above, the convolution in Eq. 12 is performed to extract location of the peak activation of ρ and

$${a}^{*}$$

to reconstruct the predicted pseudo-3-D coordinates. As illustrated in diagram 710 of FIG. 7B, the locations of peak activation in

$${a}^{*}$$

and ρ (recovered, right panel) map onto the movements of the object in the XZ plane (truth, left panel).

### Extensions of the Methodology

The approach or methodology described above in connection with coordinate systems in the world and the visual system, the mapping of position in the world onto log-polar coordinates, the building of position-tolerant filters in log-polar, as well as the various examples or demonstrations, allows for representations of the what and the where of objects in a visual system. Filters are trained, by whatever means, to describe a particular “what.” The coordinated (ρ, φ,

$${a}^{*} )$$

allow the location of that thing in the 3-D world to be inferred up to a constant. This constant is proportional to the real-world size of the object, allowing one to precisely infer its Z coordinate from the

$${a}^{*}$$

coordinate.

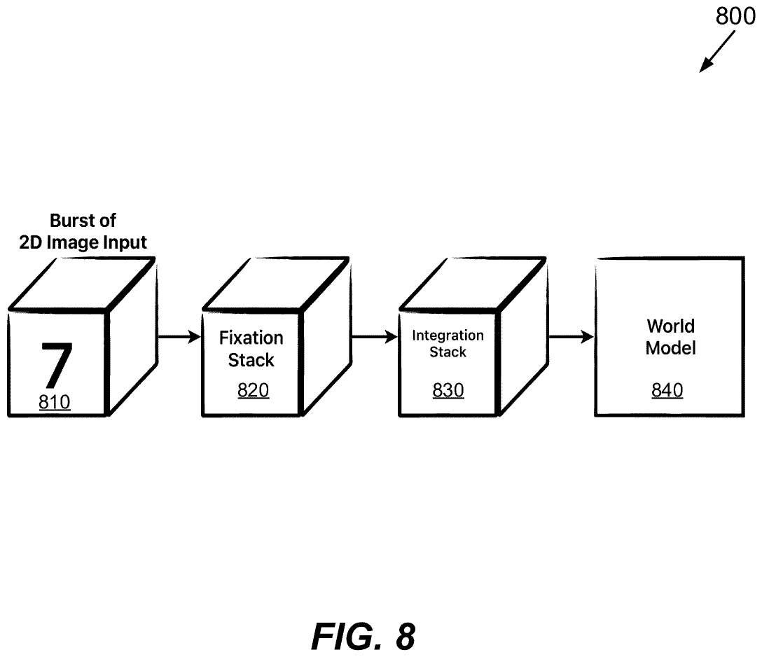

The distinction between objects and the space they occupy is fundamental to the understanding of the physical world. The use of a log-polar cortical coordinate system makes the mapping more difficult to construct. The method sketched here addresses this basic problem in a hyper-efficient computational system, at the cost of decreased acuity far from the origin. The method described can be incorporated into a complete system for dynamical computer vision (DCV) by including it with other components, as shown in FIG. 8, which describes flowchart 800 of a dynamic computer vision model. In this example, at 810, input comes in as a burst of 2-D images. At 820, these are converted to log-polar at a set of fixations and processed in the fixation stack (e.g., convolutions). At 830, the next layers in the flowchart integrate multiple fixations to decode the object identity and place it in a world model at 840.

### Additional and Alternative Embodiments

The method or algorithm described herein can be more general than, and need not be limited to, the specific choices made to construct the various examples or demonstrations described above. The general method described herein assumes the existence of filters g. It is modular with respect to ways to specify these abstract filters. In the examples described above the approach was to simply “write down” filters that were known to match test data. The general method is also modular with respect to the method of training those filters. Taken together, these two properties mean that it is possible to learn filters in whatever coordinate system is convenient.

Non-cartesian coordinates: The filters themselves can be understood as abstract spatial patterns independent of a coordinate system (see e.g., diagram 200 of FIG. 2). Given the widespread availability of images sampled over a Cartesian grid, it is not a bad starting point to specify the filters as a set of weights over a Cartesian grid. But this choice is not essential to the method, that is, the method need not be so limited, and filters can be specified over coordinates that are different than Cartesian coordinates.

The examples or demonstrations above describe g[x] as πm² weights covering a circular region of radius m. This can be understood as πm² parameters weighting a series of radial basis functions centered on each spatial location. It is possible to use a smaller number of parameters weighting any other set of basis functions. Extensive work on scale-space theory could inform the choice of spatial receptive fields (Lindeberg, T., 2021).

Training filters: It is possible to learn filters via backpropagation by sampling many images directly into cortical coordinates to minimize some objective function. But it is also possible to just learn Cartesian features using standard methods. The current method is agnostic to how those features are generated. As long as a set of filters g can be understood as images centered at the origin, as would be the case from standard CNNs, it is possible to construct corresponding \tilde{g} from those filters and interpret their position in 3-D, up to a constant that depends on the real world size of the object creating the image.

### Improved Models for Dynamic Computer Vision

The mapping from log-polar cortical coordinates to the 3-D world is an important component of general efforts to develop a brain-inspired system for dynamic computer vision. Starting from an input

$$\tilde{f} ( {r}^{*} , θ )$$

this method provides a way to construct a 3-D coordinate system (ρ, φ,

$${a}^{*} )$$

that maps onto the 3-D world. It should be straightforward to perform standard CNNs over these coordinates (summing over φ if it is desired to avoid rotation equivariance) to extract successively more sophisticated filters from subsequent layers. Convolutional filters over these 3-D coordinates will capture 3-D spatial relationships in the world. Beyond this deep CNN, the system will include several other critical components that will be sketched here.

Interpolating across the fovea: As a practical matter, it may be useful to specify some way to deal with the fovea; taken literally a log-polar coordinate system results in a singularity at the origin. One possibility is to effectively not have a fovea; simply choose

$${{r}^{*}}_{0}$$

to be the smallest possible resolution provided by the input. In this case the cortical coordinate system would effectively cover the entire plane.

However, this choice may be suboptimal in some instances. A fovea provides a small region with high visual acuity over which standard translation-equivariant convolutional filters will work well. Howard and Shankar (2018) argued that the fovea can be chosen to have a radius of 1/c pixels in order to equalize the information conveyed by objects of different apparent sizes. One approach is to simply use an analog of Eq. 12 throughout the visual field. Pixels within the fovea would be included with their values of

$${r}^{*}$$

and θ. Empirical estimates of h(ρ) should still work.

Timing: Coherent motion provides a powerful cue for shape perception that is difficult to derive from any particular static image (Murray, Kersten, Olshausen, Schrater, & Woods, 2002). In parallel, firing in early visual regions, including V1 (also known as the primary visual cortex), shows characteristic time lags (Parker et al., 2023), meaning that motion can be considered a primitive of the mammalian visual system. Following extensive work in time coding in theoretical and empirical neuroscience (Shankar & Howard, 2013; Howard et al., 2014; Bright et al., 2020; Cao, Bladon, Charczynski, Hasselmo, & Howard, 2022), extensions of the current methodology may include integrating temporal information into f. The input to the algorithm will thus be

$$\tilde{f} ( {r}^{*} , θ , {τ}^{*} ) ,$$

which can be referred to as an image packet. In early stages of the system,

$${τ}^{*}$$

will extend out to perhaps a few hundred milliseconds. Consistent with theoretical and empirical work,

$${τ}^{*}$$

will be logarithmically-compressed, as is

$${r}^{*} .$$

The position and velocity of objects in the world can be inferred by expanding the strategy used to identify the position in this disclosure. Assuming that an object matched by a filter g[x] is translated by some amount and with a particular velocity v, it is possible to ask how this object would appear in

$$( {r}^{*} , θ , {τ}^{*} ) .$$

This may enable doing 2-D convolutions between

$${\tilde{g}}_{ρ , v} ( {r}^{*} , θ , {τ}^{*} )$$

and \tilde{f}, with convolutions over

$${r}^{*} and {τ}^{*} .$$

Using spatiotemporal memory to integrate over multiple fixations: The methodology described herein can further be expanded to use spatiotemporal memory. The natural world is never static. In addition to movement of objects in the world, the human eye is essentially never still. Fixational eye movements are used to sample the world around us (see e.g., 810 and 820 of FIG. 8), moving the eyes roughly every couple hundred milliseconds. Even between fixational eye movements, microsaccades perturb the position of the eye below the threshold of conscious awareness. Despite this constant motion, an understanding of the visual world can be built up that extends over spatial scales far beyond the range of our visual receptors and integrates over long periods of time. This depends on memory. In this view, individual image packets can be integrated (see e.g., 830 of FIG. 8) into an updated “world model” (see e.g., 840 of FIG. 8). The integration of distinct inputs into a spatiotemporal map builds on a large amount of prior work both in theoretical neuroscience and in computational work using deep networks (Maini et al., 2023).

Based on the various approaches and techniques described above with respect to FIGS. 1A-8, and more specifically based on the methodology described above in connection with coordinate systems in the world and the visual system, the mapping of position in the world onto log-polar coordinates, the building of position-tolerant filters in log-polar, as well as the various examples or demonstrations, the following features for different methods and systems are proposed as part of this disclosure.

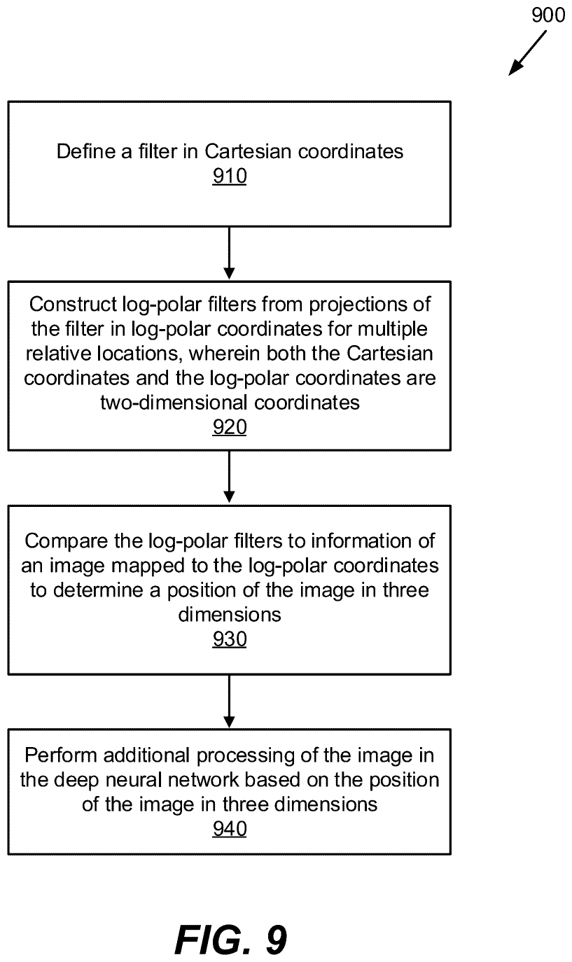

FIG. 9 illustrates a method 900 for processing images within a deep neural network. At 910, the method includes defining a filter in Cartesian coordinates. The method further includes, at 920, constructing log-polar filters from projections of the filter in log-polar coordinates for multiple relative locations, wherein both the Cartesian coordinates and the log-polar coordinates are two-dimensional coordinates. The method also includes, at 930, comparing the log-polar filters to information of an image mapped to the log-polar coordinates for determining a position of the image in three dimensions. The comparing can be based on a convolution operation, however, other techniques can also be used. Additionally, the method includes, at 940, performing additional processing of the image in the deep neural network based on the position of the image in three dimensions. The position of the image in three dimensions can be accurate up to a constant that depends on the real-world size of an object creating the image.

In an aspect, the method 900 further includes receiving information of the image in the Cartesian coordinates and mapping the information of the image in the Cartesian coordinates to the log-polar coordinates to produce the information of the image mapped into the log-polar coordinates.

In another aspect, for the method 900, the comparing results in a set of parameters that are used for the determining of the position of the image in three dimensions. A subset of the set of parameters correspond to displacements associated with the multiple relative locations, and the remaining parameters of the set of parameters convey information about the scale of the matching resulting from the comparing.

In another aspect, for the method 900, the comparing further includes applying a normalization factor to adjust for the change in area covered by the projections of the filter in log-polar coordinates for multiple relative locations.

In another aspect, for the method 900, the log-polar coordinates and a fovea at the center of the log-polar coordinates form cortical coordinates, and a resolution associated with the projections of the filter in log-polar coordinates for multiple relative locations is based on whether there is an overlap with a region covered by the fovea.

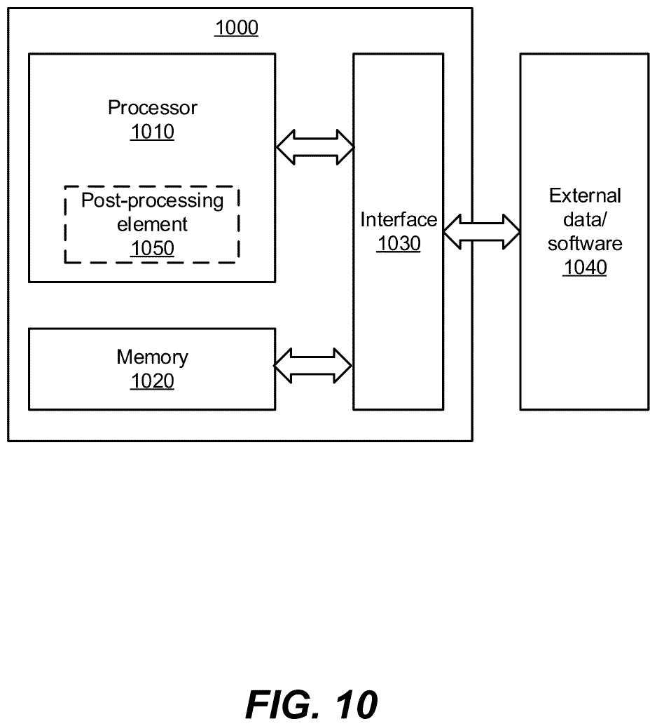

FIG. 10 illustrates a hardware system 1000 configured to process images within a deep neural network that is implemented as part of the hardware system 1000. Hardware system 1000 can include a processor 1010, a memory 1020, and an interface 1030. Communication can occur between hardware system 1000 and an external data source or software 1040. In some implementations, at least a portion of external data/software 1040 can be part of hardware system 1000.

Memory 1020, processor 1010, and/or interface 1030 can be part of a central processing unit (CPU), a graphical processing unit (GPU), an application specific integrated circuit (ASIC), or a combination thereof.

In one aspect, processor 1010 can include multiple processors and/or processing cores, which can be of the same or different types. For example, processor 1010 can include a combination of one or more CPUs, one or more GPUs, and/or one or more ASICs. When multiple processors are used, they could be co-located or distributed. For example, the multiple processors could be on a single card or in multiple cards, in a single server or in multiple servers, and/or in a single data center or in multiple data centers.

Hardware system 1000 can be configured to perform or execute operations, processes, and/or methods associated with the processing images, including method 900 above.

In one implementation, hardware system 1000 can be a system to process images within a deep neural network. The deep neural network can be implemented in hardware system 1000 through processor 1010, for example. Processor 1010 can be configured to define a filter in Cartesian coordinates. Processor 1010 can be further configured to construct log-polar filters from projections of the filter in log-polar coordinates for multiple relative locations, wherein both the Cartesian coordinates and the log-polar coordinates are two-dimensional coordinates. Processor 1010 can be additionally configured to compare the log-polar filters to information of an image mapped into the log-polar coordinates to determine a position of the image in three dimensions. The comparison can be based on a convolution operation, however, other techniques can also be used. Moreover, processor 1010 can be configured to perform additional processing of the image in the deep neural network based on the position of the image in three dimensions. The position of the image in three dimensions can be accurate up to a constant that depends on the real-world size of an object creating the image.

In this implementation of hardware system 1000, memory 1020 can be configured to store, at least temporarily, one or more of the filter in Cartesian coordinates, the projections of the filter in log-polar coordinates for multiple relative locations, the information of an image mapped into the log-polar coordinates, and the position of the image in three-dimensions.

In this implementation of hardware system 1000, interface 1030 is part of hardware system 1000 and is configured to receive image information (possibly in one or more coordinate systems) in addition to information for operations of the deep neural network, and to communicate results from operations performed on the image information by the deep neural network. For example, interface 1030 can be configured to receive information of the image in the Cartesian coordinates.

In this implementation of hardware system 1000, processor 1010 can be further configured to map the information of the image in the Cartesian coordinates to the log-polar coordinates to produce the information of the image mapped into the log-polar coordinates.

In this implementation of hardware system 1000, the comparison performed by processor 1010 can result in a set of parameters that are used to determine the position of the image in three dimensions. A subset of the set of parameters correspond to displacements associated with the multiple relative locations, and the remaining parameters of the set of parameters convey information about the scale of the matching resulting from the comparison.

In this implementation of hardware system 1000, the comparison performed by processor 1010 further includes application of a normalization factor to adjust for the change in area covered by the projections of the filter in log-polar coordinates for multiple relative locations.

In this implementation of hardware system 1000, the log-polar coordinates and a fovea at the center of the log-polar coordinates form cortical coordinates, and a resolution associated with the projections of the filter in log-polar coordinates for multiple relative locations is based on whether there is an overlap with a region covered by the fovea.

In this implementation of hardware system 1000, processor 1010 processor can include one or more CPUs, one or more GPUs, one or more ASICs, or a combination thereof.

In this implementation, a post-processing element (e.g., post-processing element 1050 in FIG. 10) can be configured to perform the further processing of the image in the deep neural network based on the position of the image in three dimensions. The post processing element can be part of processor 1010 (as shown in FIG. 10) or can be part of hardware system 1000 but separate from processor 1010.

Based on the various approaches and techniques described above with respect to FIGS. 1A-10, and more specifically based on the methodology described above in connection with coordinate systems in the world and the visual system, the mapping of position in the world onto log-polar coordinates, the building of position-tolerant filters in log-polar, as well as the various examples or demonstrations, the following computer readable medium features are proposed as part of this disclosure.

A computer readable medium having program instructions to process information, wherein execution of the program instructions by one or more processors of a hardware system (e.g., processor 1010 of hardware system 1000) causes the one or more processors to define a filter in Cartesian coordinates; construct log-polar filters from projections of the filter in log-polar coordinates for multiple relative locations, wherein both the Cartesian coordinates and the log-polar coordinates are two-dimensional coordinates; compare the log-polar filters to information of an image mapped into the log-polar coordinates for determining a position of the image in three dimensions; and perform additional processing of the image in the deep neural network based on the position of the image in three dimensions. The position of the image in three dimensions is accurate up to a constant that depends on the real-world size of an object creating the image. The comparison described above can be based on a convolution operation, however, other techniques can also be used.

In an aspect of the computer readable medium, execution of the program instructions by the one or more processors of the hardware system further causes the one or more processors to receive information of the image in the Cartesian coordinates and map the information of the image in the Cartesian coordinates to the log-polar coordinates to produce the information of the image mapped into the log-polar coordinates.

In another aspect of the computer readable medium, the comparison results in a set of parameters that are used for the determining of the position of the image in three dimensions, and a subset of the set of parameters correspond to displacements associated with the multiple relative locations, and the remaining parameters of the set of parameters convey information about the scale of the matching resulting from the comparison.

In another aspect of the computer readable medium, execution of the program instructions by the one or more processors of the hardware system further causes the one or more processors to apply, as part of the comparison, a normalization factor to adjust for the change in area covered by the projections of the filter in log-polar coordinates for multiple relative locations.

In another aspect of the computer readable medium, the log-polar coordinates and a fovea at the center of the log-polar coordinates form cortical coordinates, and a resolution associated with the projections of the filter in log-polar coordinates for multiple relative locations is based on whether there is an overlap with a region covered by the fovea.

1. A method for processing images within a deep neural network, comprising:
defining a filter in Cartesian coordinates;
constructing log-polar filters from projections of the filter in log-polar coordinates for multiple relative locations, wherein both the Cartesian coordinates and the log-polar coordinates are two-dimensional coordinates;
comparing the log-polar filters to information of an image mapped into the log-polar coordinates for determining a position of the image in three dimensions; and
performing additional processing of the image in the deep neural network based on the position of the image in three dimensions.

2. The method of claim 1, further comprising:
receiving information of the image in the Cartesian coordinates; and
mapping the information of the image in the Cartesian coordinates to the log-polar coordinates to produce the information of the image mapped into the log-polar coordinates.

3. The method of claim 1, wherein:
the comparing results in a set of parameters that are used for the determining of the position of the image in three dimensions, and
a subset of the set of parameters correspond to displacements associated with the multiple relative locations, and the remaining parameters of the set of parameters convey information about the scale of the matching resulting from the comparing.

4. The method of claim 1, wherein the comparing further includes applying a normalization factor to adjust for the change in area covered by the projections of the filter in log-polar coordinates for multiple relative locations.

5. The method of claim 1, wherein the position of the image in three dimensions is accurate up to a constant that depends on the real-world size of an object creating the image.

6. The method of claim 1, wherein:
the log-polar coordinates and a fovea at the center of the log-polar coordinates form cortical coordinates, and
a resolution associated with the projections of the filter in log-polar coordinates for multiple relative locations is based on whether there is an overlap with a region covered by the fovea.

7. The method of claim 1, wherein the comparing includes a convolution operation.

8. A system to process images within a deep neural network, comprising:
a processor configured to:
define a filter in Cartesian coordinates;
construct log-polar filters from projections of the filter in log-polar coordinates for multiple relative locations, wherein both the Cartesian coordinates and the log-polar coordinates are two-dimensional coordinates;
compare the log-polar filters to information of an image mapped into the log-polar coordinates to determine a position of the image in three dimensions; and
perform additional processing of the image in the deep neural network based on the position of the image in three dimensions; and
a memory configured to store, at least temporarily, one or more of the filter in Cartesian coordinates, the projections of the filter in log-polar coordinates for multiple relative locations, the information of an image mapped into the log-polar coordinates, and the position of the image in three-dimensions.

9. The system of claim 8, further comprising:
an interface configured to receive information of the image in the Cartesian coordinates,
wherein the processor is further configured to map the information of the image in the Cartesian coordinates to the log-polar coordinates to produce the information of the image mapped into the log-polar coordinates.

10. The system of claim 8, wherein the comparison by the processor includes a convolution operation.

11. The system of claim 8, wherein:
the comparison by the processor results in a set of parameters that are used to determine the position of the image in three dimensions, and
a subset of the set of parameters correspond to displacements associated with the multiple relative locations, and the remaining parameters of the set of parameters convey information about the scale of the matching resulting from the comparison.

12. The system of claim 8, wherein the comparison by the processor includes application of a normalization factor to adjust for the change in area covered by the projections of the filter in log-polar coordinates for multiple relative locations.

13. The system of claim 8, wherein the position of the image in three dimensions is accurate up to a constant that depends on the real-world size of an object creating the image.

14. The system of claim 8, wherein:
the log-polar coordinates and a fovea at the center of the log-polar coordinates form cortical coordinates, and
a resolution associated with the projections of the filter in log-polar coordinates for multiple relative locations is based on whether there is an overlap with a region covered by the fovea.

15. The system of claim 8, wherein the processor includes a post-processing element configured to perform the additional processing of the image in the deep neural network based on the position of the image in three dimensions.

16. The system of claim 8, wherein the processor includes one or more central processing units (CPUs), one or more graphics processing units (GPUs), one or more application specific integrated circuits (ASICs), or a combination thereof.

17. A computer-readable medium having program instructions to process images within a deep neural network, wherein execution of the program instructions by one or more processors of a hardware system causes the one or more processors to:
define a filter in Cartesian coordinates;
construct log-polar filters from projections of the filter in log-polar coordinates for multiple relative locations, wherein both the Cartesian coordinates and the log-polar coordinates are two-dimensional coordinates;
compare the log-polar filters to information of an image mapped into the log-polar coordinates for determining a position of the image in three dimensions; and
perform additional processing of the image in the deep neural network based on the position of the image in three dimensions.

18. The computer-readable medium of claim 17, wherein execution of the program instructions by the one or more processors of the hardware system further causes the one or more processors to:
receive information of the image in the Cartesian coordinates; and
map the information of the image in the Cartesian coordinates to the log-polar coordinates to produce the information of the image mapped into the log-polar coordinates.

19. The computer-readable medium of claim 17, wherein the comparison includes a convolution operation.

20. The computer-readable medium of claim 17, wherein:
the comparison results in a set of parameters that are used for the determining of the position of the image in three dimensions, and
a subset of the set of parameters correspond to displacements associated with the multiple relative locations, and the remaining parameters of the set of parameters convey information about the scale of the matching resulting from the comparison.
